(19) United States
(12) Patent Application Publication
(10) Pub. No.: US 2009/0154615 A1
(43) Pub. Date: Jun. 18, 2009

(54) INTEGRATED CIRCUIT FOR PROCESSING MULTI-CHANNEL RADIO SIGNAL

(76) Inventors: Katsumasa Hijikata, Osaka (JP); Joji Hayashi, Osaka (JP)

Correspondence Address: MCDERMOTT WILL & EMERY LLP, 600 13TH STREET, NW, WASHINGTON, DC, 20005-3096, US

(21) Appl. No.: 12/299,846

(22) PCT Filed: Nov. 20, 2007
(86) PCT No.: PCT/JP07/72453

§ 371 Date: Nov. 6, 2008

(30) Foreign Application Priority Data
Feb. 16, 2007 (JP) 2007-036303

(51) Int. Cl. H04L 27/06

(52) U.S. Cl. 375/344

(57) ABSTRACT

A multi-channel radio signal processing integrated circuit (10A) includes: an analog signal processing unit (101) for generating a local signal based on an externally supplied reference clock signal and selecting a desired channel from the multi-channel radio signal using the local signal; a digital signal processing unit (102) for performing digital demodulation of a signal of the channel selected by the analog signal processing unit (101); an operation clock generating unit (103) for generating an operation clock signal for the digital signal processing unit (102); and a control unit (104) for designating a frequency of the operation clock signal to be generated by the operation clock generating unit (103) in response the channel selected by the analog signal processing unit (101).

### TECHNICAL FIELD

The present invention relates to an integrated circuit for processing a received multi-channel radio signal, in particular to an integrated circuit for processing a broadband multi-channel radio signal for digital television broadcasting and the like.

### BACKGROUND ART

In general, a receiver system for multi-channel radio communication includes an analog signal processing unit for selecting a desired channel from a received multi-channel radio signal, a digital signal processing unit for performing digital demodulation of a signal of the selected channel and an operation clock generating unit for generating an operation clock signal for the digital signal processing unit based on a reference clock signal supplied from a quartz oscillator or the like. The analog signal processing unit is composed of a bipolar transistor having excellent high frequency and noise characteristics. The digital signal processing unit is composed of a MOS transistor which is advantageous in terms of cost, power consumption and circuit footprint.

In such a receiver system, a harmonic (digital noise) of an operation clock signal supplied from the operation clock generating unit to the digital signal processing unit may leak to the analog signal processing unit to become interference, thereby reducing receiver sensitivity. An explanation of such inconvenience is given below by taking digital terrestrial television broadcasting for mobile terminals (one segment broadcasting) as an example.

The one segment broadcasting contains 49 channels ranging from a channel 13 (474 MHz) to a channel 62 (768 MHz) in a UHF band. Each of the channels uses 6 MHz and an occupied bandwidth of 430 kHz. When the digital signal processing unit of the receiver system is operated by an operation clock signal of 30 MHz, a harmonic of the signal leaks to the analog signal processing unit. As a result, spurious is generated in an integral multiple frequency of 30 MHz. In particular, since the 25^{th} harmonic and a center frequency of a channel 59 are both 750 MHz, the harmonic becomes interference and reduces the receiver sensitivity to the channel.

In view of the above-mentioned problem, a capacitance value of a capacity variable diode of the operation clock generating unit is changed to slightly vary the frequency of the operation clock signal so that mutual interference between the operation clock signal and the channel to be selected is avoided (e.g., see Patent Literature 1). Further, a high-speed operation clock signal for a CPU or the like, which does not affect the channel to be selected, is generated from a low-speed reference clock signal for a time-of-day clock (e.g., see Patent Literature 2). Still further, an interference level of the spurious in the received frequency is measured by a built-in antenna so that the frequency of the operation clock signal is varied when the interference level is equal or higher than a reference value (e.g., see Patent Literature 3).

### Patent Literature 1: Publication of Japanese Patent Application No. 7-303079 (pp. 1-4, FIGS. 1-2)

### Patent Literature 2: Publication of Japanese Patent Application No. 11-355161 (pp. 1-4, FIGS. 1-3)

### Patent Literature 3: Publication of Japanese Patent No. 2000-68872 (pp. 1-12, FIGS. 1-10)

### DISCLOSURE OF THE INVENTION

### Problem that the Invention is to Solve

The above-described conventional receiver systems have the following drawbacks. In the receiver system according to Patent Literature 1, the frequency of the operation clock signal is varied only within a range of ±several tens ppm. Therefore, for the digital terrestrial television broadcasting, in which an occupied bandwidth per channel is high, the influence of the digital noise cannot be sufficiently removed. According to the receiver system of Patent Literature 2, when a local signal for the analog signal processing unit is generated from the low-speed reference clock signal, the frequency ratio between these signals becomes extremely high. As a result, a phase noise characteristic of the local signal is degraded and sufficient receiver sensitivity cannot be obtained. According to the receiver system of Patent Literature 3, a large-scale circuit such as a built-in antenna is required for harmonic detection, resulting in complicated control. This is disadvantageous in terms of power consumption and cost.

As the performance of the MOS transistors has dramatically been enhanced with the development of a CMOS process technology in recent years, radio signal processing by the MOS transistors is now becoming possible. This allows mounting the analog signal processing unit and the digital signal processing unit on the same CMOS substrate. Therefore, expectations are placed not only on the reduction in size, power consumption and cost of the receiver system, but also on the installation of various radio communication applications in radio communication devices such as cellular phones.

When the analog signal processing unit and the digital signal processing unit are composed of different chips, the influence of digital noise is relatively easily avoided by taking measures against it, such as optimization of component layout in a module, enhancement of a power supply and provision of an electromagnetic shield. However, when these units are provided on a single chip, it is difficult to take the same measures. Further, as the analog signal processing unit and the digital signal processing unit share the same substrate, there arises another problem of degradation of receiver sensitivity due to propagation of noise through the substrate.

With the foregoing in mind, an object of the present invention is to reduce the degradation of receiver sensitivity caused by digital noise in a multi-channel radio signal processing integrated circuit.

### Means of Solving the Problem

A means taken by the present invention to achieve the object is to provide an integrated circuit for processing a received multi-channel radio signal including: an analog signal processing unit for generating a local signal based on a reference clock signal supplied from the outside of the integrated circuit and selecting a desired channel from the multi-channel radio signal using the local signal; a digital signal processing unit for performing digital demodulation of a signal of the channel selected by the analog signal processing unit; an operation clock generating unit for generating an operation clock signal for the digital signal processing unit based on the reference clock signal; and a control unit for designating a frequency of the operation clock signal to be generated by the operation clock generating unit in response to the channel selected by the analog signal processing unit.

According to the above-mentioned means, an operation clock signal which does not interfere with the channel selected by the analog signal processing unit is generated based on the reference clock signal based on which the local signal of the analog signal processing unit is generated. Then, the digital signal processing unit is driven by the operation clock signal. Therefore, in the integrated circuit for processing the multi-channel radio signal, degradation of receiver sensitivity caused by digital noise is reduced.

In a preferable manner, the control unit designates the frequency of the operation clock signal by referring to a table in which channels selectable in the analog signal processing unit and frequencies of the operation clock signal to be designated are so associated with each other that a corresponding frequency is designated in response to a selected channel. As the frequency of the operation clock signal is designated in accordance with the information indicated in the table, the designation is performed with ease.

More specifically, the operation clock generating unit has a divider for dividing the frequency of the reference clock signal in a variable division ratio and the control unit designates the division ratio of the divider. Alternatively, the operation clock generating unit has a PLL for outputting the operation clock signal in response to the reference clock signal and the control unit designates an output frequency of the PLL. The PLL performs multiplication or fractional multiplication of the frequency of the reference clock signal to output the operation clock signal. In a preferable manner, the control unit designates the output frequency of the PLL so that a harmonic of the operation clock signal and a harmonic of phase noise in a loop band of the PLL are deviated from the channel selected by the analog signal processing unit. As a result, degradation of receiver sensitivity due to the harmonic of the PLL phase noise is reduced.

Another means taken by the present invention is to provide an integrated circuit for processing a received multi-channel radio signal including: an analog signal processing unit for generating a local signal based on a reference clock signal supplied from an external oscillator capable of changing an oscillatory frequency and selecting a desired channel from the multi-channel radio signal using the local signal; a digital signal processing unit for receiving the reference clock signal as an operation clock signal and performing digital demodulation of a signal of the channel selected by the analog signal processing unit; and a control unit for designating a frequency to be oscillated by the external oscillator in response to the channel selected by the analog signal processing unit.

According to the above-mentioned means, the digital signal processing unit is driven by the reference clock signal based on which the local signal of the analog signal processing unit is generated and the frequency of the reference clock signal is set to a certain frequency that does not interfere with the channel selected by the analog signal processing unit. Therefore, in the integrated circuit for processing the multi-channel radio signal, the degradation of receiver sensitivity caused by digital noise is reduced. Further, since there is no need of generating the operation clock signal for the digital signal processing unit within the integrated circuit, the footprint of the integrated circuit is reduced.

Another means taken by the present invention is to provide an integrated circuit for processing a received multi-channel radio signal including: a selector unit for receiving a plurality of different reference clock signals from an external oscillator and selectively outputting any one of the reference clock signals; an analog signal processing unit for generating a local signal based on any one of the plurality of reference clock signals and selecting a desired channel from the multi-channel radio signal using the local signal; a digital signal processing unit for receiving the reference clock signal output from the selector unit as an operation clock signal and performing digital demodulation of a signal of the channel selected by the analog signal processing unit; and a control unit for controlling the signal selection by the selector unit in response to the channel selected by the analog signal processing unit. The analog signal processing unit may receive the reference clock signal output from the selector unit.

According to the above-described means, a certain reference clock signal that does not interfere with the channel selected by the analog signal processing unit is selected as the operation clock signal for the digital signal processing unit from the plurality of reference clock signals including the reference clock signal based on which the local signal of the analog signal processing unit is generated. Therefore, in the integrated circuit for processing the multi-channel radio signal, the degradation of receiver sensitivity caused by digital noise is reduced. Further, since the operation clock signal for the digital signal processing unit is obtained by merely selecting any one of the plurality of reference clock signals, the circuit structure is simplified and the footprint of the integrated circuit is reduced.

### EFFECT OF THE INVENTION

According to the present invention, in a multi-channel radio signal processing integrated circuit, in particular in a 1-chip multi-channel radio signal processing integrated circuit, the degradation of receiver sensitivity caused by digital noise is reduced.

### BRIEF DESCRIPTION OF DRAWINGS

FIG. 1 is a block diagram illustrating a multi-channel radio signal processing integrated circuit according to Embodiment 1.

FIG. 2 is a block diagram illustrating an operation clock generating unit composed of a divider.

FIG. 3 is a block diagram illustrating an operation clock generating unit composed of a PLL.

FIG. 4 is a table indicating the relationship between harmonics of 28 MHz and 35 MHz operation clock signals and channels for one segment broadcasting affected by the harmonics.

FIG. 5 is a table to be used when the operation clock generating unit is composed of a divider.

FIG. 6 is a table to be used when the operation clock generating unit is composed of a multiplication PLL.

FIG. 7 is a table indicating the relationship between harmonics of 28 MHz and 30 MHz operation clock signals and channels for one segment broadcasting affected by the harmonics.

FIG. 8 is a table to be used when the operation clock generating unit is composed of a fractional multiplication PLL.

FIG. 9 is a block diagram illustrating a multi-channel radio signal processing integrated circuit according to Embodiment 2.

FIG. 10 is a graph illustrating the relationship between a control voltage and an oscillatory frequency of an external oscillator.

FIG. 11 is a table used for the control of the external oscillator.

FIG. 12 is a block diagram illustrating a multi-channel radio signal processing integrated circuit according to Embodiment 3.

FIG. 13 is a table used for the selection of the external oscillator.

FIG. 14 shows an appearance of a multi-channel broadcasting receiver equipped with the multi-channel radio signal processing integrated circuit of the present invention.

FIG. 15 shows an appearance of a multi-channel radio communication device equipped with the multi-channel radio signal processing integrated circuit of the present invention.

### EXPLANATION OF REFERENCE NUMERALS

10A-10C Multi-channel radio signal processing integrated circuit
101 Analog signal processing unit
102 Digital signal processing unit
103 Operation clock generating unit
103a Divider
103b PLL
104 Control unit
105 Table
106 Selector unit
30A-30C External oscillator
100 Digital television receiving set (multi-channel broadcasting receiver)
200 Cellular phone (multi-channel radio communication device)

### BEST MODE FOR CARRYING OUT THE INVENTION

Hereinafter, best modes for carrying out the present invention are described with reference to the drawings.

### Embodiment 1

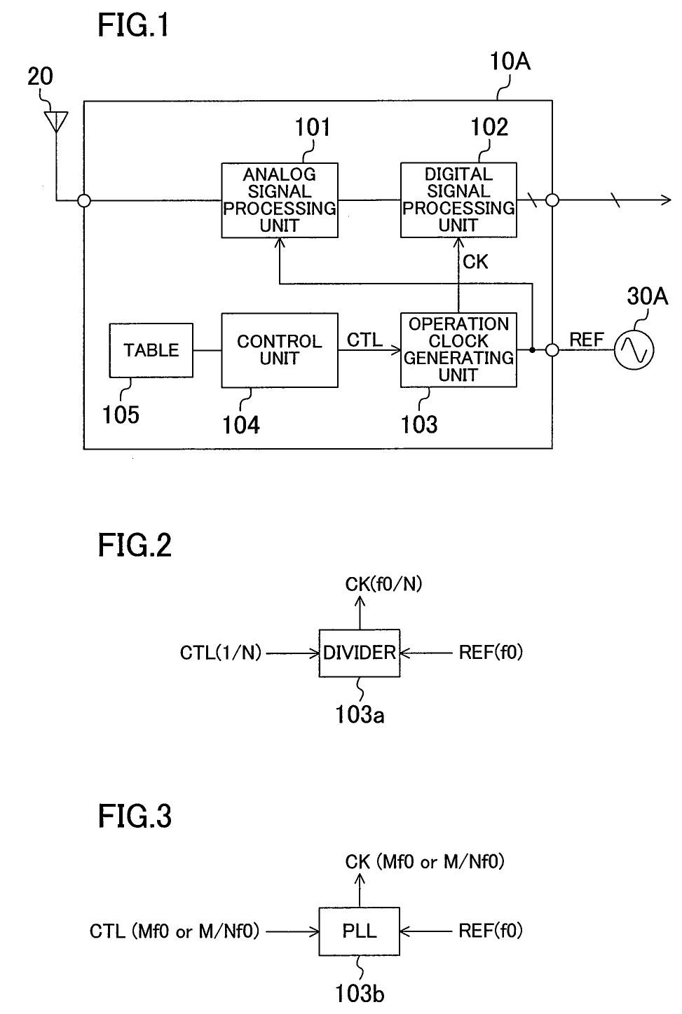

FIG. 1 shows the structure of a multi-channel radio signal processing integrated circuit according to Embodiment 1. In the integrated circuit 10A, an analog signal processing unit 101 receives a multi-channel radio signal received by an antenna 20 and selects a desired channel from the received signal. More specifically, the analog signal processing unit 101 generates a local signal based on a high-precision reference clock signal REF supplied from an external oscillator 30A such as a quartz oscillator, and then selects the desired channel using the local signal. A digital signal processing unit 102 performs digital demodulation of a signal of the channel selected by the analog signal processing unit 101. For example, in the case of digital television broadcasting, video data, audio data, caption data and other data are extracted by the digital demodulation. An operation clock generating unit 103 generates an operation clock signal CK for driving the operation clock generating unit 102 based on the reference clock signal REF. A control unit 104 outputs a control signal CTL to the operation clock generating unit 103 to designate a frequency of the operation clock signal CK to be generated by the operation clock generating unit 103. A table 105 stores information related to the designation.

More specifically, the operation clock generating unit 103 may be composed of a divider capable of changing the division ratio. As shown in FIG. 2, when division by 1/N is designated by the control signal CTL, the divider 103a divides a frequency of a reference clock signal REF having a frequency of f0 by 1/N to generate an operation clock signal CK having a frequency of f0/N.

Further, the operation clock generating unit 103 may be composed of a PLL (a phase locked loop). As shown in FIG. 3, when multiplication by M is designated by the control signal CTL, a PLL 103b multiplies a frequency of a reference clock signal REF having a frequency of f0 by M to generate an operation clock signal CK having a frequency of Mf0. The PLL 103b may fractionally multiply the frequency of the reference clock signal REF. In this case, the PLL 103b generates an operation clock signal CK having a frequency of M/N f0.

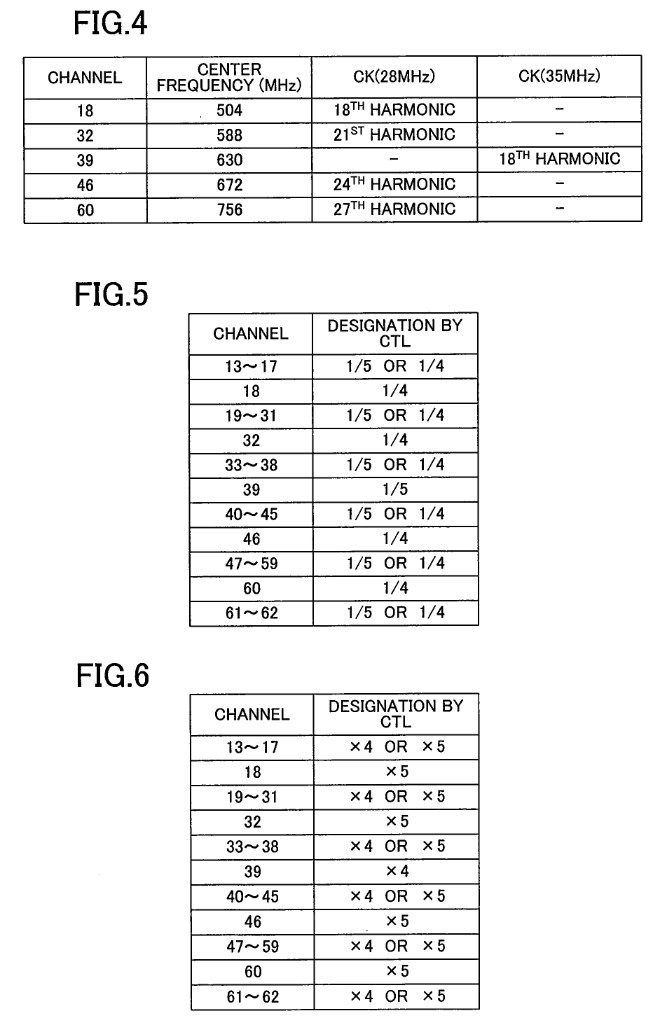

Next, taking one segment broadcasting as an example, the designation of the frequency of the operation clock signal CK by the control unit 104 is explained below. FIG. 4 is a table indicating the relationship between harmonics of 28 MHz and 35 MHz operation clock signals CK and channels for the one segment broadcasting affected by the harmonics. As shown in the table, the 18^{th} harmonic and other harmonics of the 28 MHz operation clock signal CK make interference with a channel 18 and other channels. On the other hand, the 18^{th} harmonic of the 35 MHz operation clock signal CK makes interference with a channel 39. Therefore, the frequency of the operation clock signal CK is set to 35 MHz when the channel 18 and other channels are selected by the analog signal processing unit 101 or it is set to 28 MHz when the channel 39 is selected.

More specifically, when the operation clock generating unit 103 is composed of the divider 103a as shown in FIG. 2, a table shown in FIG. 5 is used as the table 105. When the frequency of the reference clock signal REF is 140 MHz, it is divided by ⅕ or ¼ to obtain the 28 MHz or 35 MHz operation clock signal CK. By referring to the table 105, the control unit 104 designates the division ratio of the divider 103a in response to the channel selected by the analog signal processing unit 101. That is, when the channel 18 and other channels are selected, the divider 103a is designated to perform division by ¼. On the other hand, when the channel 39 is selected, the divider 103a is designated to perform division by ⅕. When the channel 13 and other channels are selected, the divider 103a is designated to perform division by ⅕ or ¼ as the frequency of the operation clock signal CK may be either of 28 MHz and 35 MHz.

More specifically, when the operation clock generating unit 103 is composed of the PLL 103b (in particular, a multiplication PLL) as shown in FIG. 3, a table shown in FIG. 6 is used as the table 105. When the frequency of the reference clock signal REF is 7 MHz, it is multiplied by 4 or 5 to obtain the 28 MHz or 35 MHz operation clock signal CK. By referring to the table 105, the control unit 104 designates the output frequency of the PLL 103b in response to the channel selected by the analog signal processing unit 101. That is, when the channel 18 and other channels are selected, the PLL 103b is designated to perform multiplication by 5. On the other hand, when the channel 39 is selected, the PLL 103b is designated to perform multiplication by 4. When the channel 13 and other channels are selected, the PLL 103b is designated to perform multiplication by 4 or 5 as the frequency of the operation clock signal CK may be either of 28 MHz and 35 MHz.

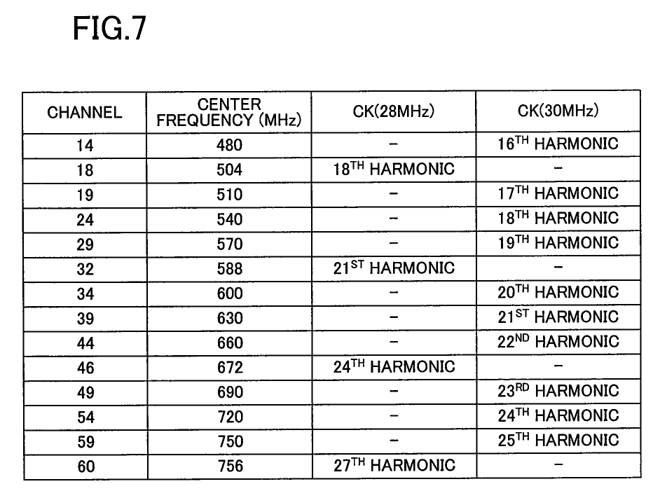

FIG. 7 is a table indicating the relationship between harmonics of the 28 MHz and 30 MHz operation clock signals CK and channels for one segment broadcasting affected by the harmonics. As shown in the table, the 18^{th} harmonic and the other harmonics of the 28 MHz operation clock signal CK make interference with the channel 18 and other channels. Further, the 16^{th} harmonic and other harmonics of the 30 MHz operation clock signal CK make interference with the channel 14 and other channels. Therefore, the frequency of the operation clock signal CK is set to 30 MHz when the channel 18 and other channels are selected by the analog signal processing unit 101 or it is set to 28 MHz when the channel 14 and other channels are selected.

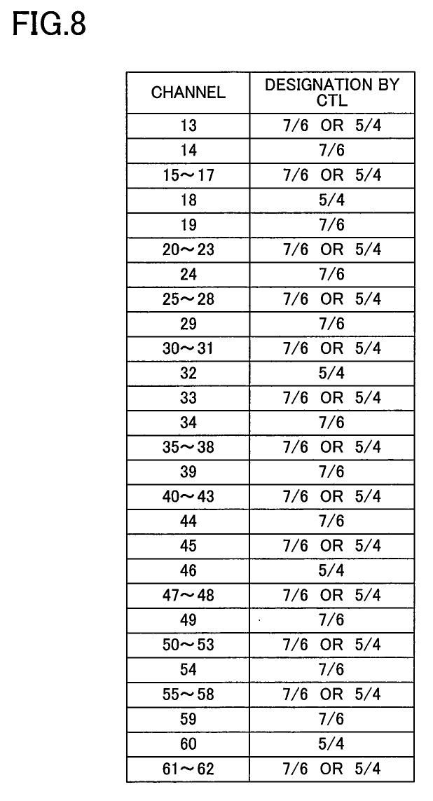

More specifically, when the operation clock generating unit 103 is composed of the PLL 103b (in particular, a fractional multiplication PLL) as shown in FIG. 3, a table shown in FIG. 8 is used as the table 105. When the frequency of the reference clock signal REF is 24 MHz, it is multiplied by 7/6 or 5/4 to obtain the 28 MHz or 30 MHz operation clock signal CK. By referring to the table 105, the control unit 104 designates the output frequency of the PLL 103b in response to the channel selected by the analog signal processing unit 101. That is, when the channel 14 and other channels are selected, the PLL 103b is designated to perform multiplication by 7/6. On the other hand, when the channel 18 and the other channels are selected, the PLL 103b is designated to perform multiplication by 5/4. When the channel 13 and other channels are selected, the PLL 103b is designated to perform multiplication by 7/6 or 5/4 as the frequency of the operation clock signal CK may be either of 28 MHz and 30 MHz.

As described above, in the multi-channel radio signal processing integrated circuit according to the present embodiment, the receiver sensitivity of the analog signal processing unit to the received channel is not degraded by the harmonics of the operation clock signal for the digital signal processing unit.

When the operation clock generating unit 103 is composed of the PLL, a harmonic of phase noise in a loop band of the PLL may interfere with the received channel, thereby reducing the receiver sensitivity. For example, when a 27.5 MHz operation clock signal CK is supplied from the operation clock generating unit 103 to the digital signal processing unit 102, the 19^{th} harmonic (a frequency of 522.5 MHz) of the signal is deviated only by 500 kHz from 522 MHz which is a center frequency of a channel 21 for the one segment broadcasting. However, when the harmonic of the phase noise makes interference with the channel, the receiver sensitivity to the channel may be degraded. Therefore, when the PLL is employed as the operation clock generating unit 103, it is preferable to generate the operation clock signal CK while paying attention to the harmonic of the phase noise.

### Embodiment 2

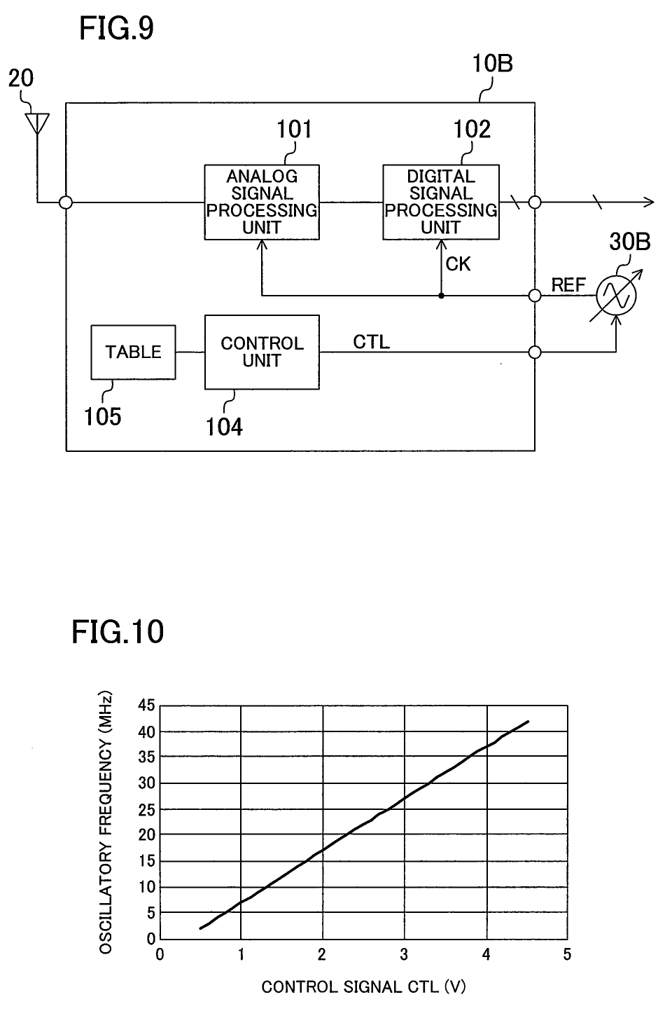

FIG. 9 shows the structure of a multi-channel radio signal processing integrated circuit according to Embodiment 2. In the integrated circuit 10B, an analog signal processing unit 101 receives a multi-channel radio signal received by an antenna 20 and selects a desired channel from the received signal. More specifically, the analog signal processing unit 101 generates a local signal based on a high-precision reference clock signal REF supplied from an external oscillator 30B such as a quartz oscillator, and then selects the desired channel using the local signal. A digital signal processing unit 102 performs digital demodulation of a signal of the channel selected by the analog signal processing unit 101. For example, in the case of digital television broadcasting, video data, audio data, caption data and other data are extracted by the digital demodulation. The digital signal processing unit 102 is operated upon receiving the reference clock signal REF as an operation clock signal CK. A control unit 104 outputs a control signal CTL to the external oscillator 30B to designate a frequency to be oscillated. A table 105 stores information related to the designation.

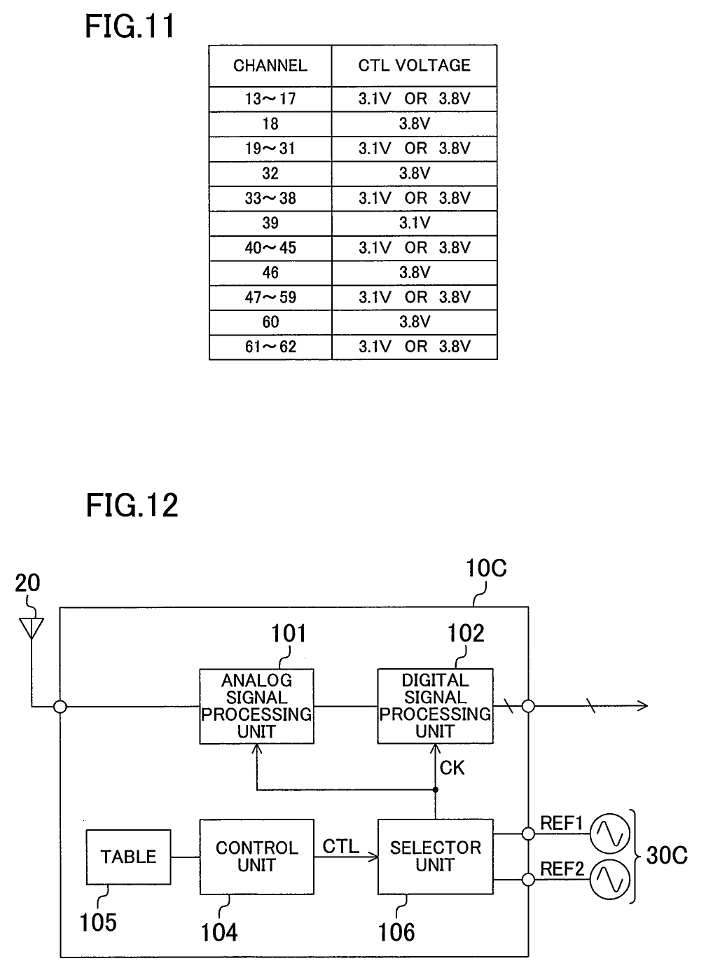

As shown in FIG. 10, an oscillatory frequency of the external oscillator 30B varies in response to a voltage of the control signal CTL. For example, when a 3.1 V or 3.8 V control signal CTL is applied, the external oscillator 30B oscillates at a frequency of 28 MHz or 35 MHz. The harmonics of the operation clock signals CK having these frequencies and the channels for one segment broadcasting affected by the harmonics establish the relationship as shown in FIG. 4. Therefore, when the external oscillator 30B is controlled by the 3.1 V or 3.8 V control signal CTL, a table shown in FIG. 11 is used as the table 105. By referring to the table 105, the control unit 104 designates the oscillatory frequency of the external oscillator 30B in response to the channel selected by the analog signal processing unit 101. That is, the control signal CTL is set to 3.8 V when the channel 18 and the other channels are selected or it is set to 3.1 V when the channel 39 is selected. When the channel 13 and other channels are selected, the control signal CTL is set to 3.1 V or 3.8 V as the frequency of the operation clock signal CK may be either of 28 MHz and 35 MHz.

According to the present embodiment, there is no need of providing a circuit for generating the operation clock signal for the digital signal processing unit. Therefore, as compared with the circuit of Embodiment 1, the circuit size is reduced. For waveform shaping of the reference clock signal REF, a buffer circuit may be provided.

### Embodiment 3

FIG. 12 shows the structure of a multi-channel radio signal processing integrated circuit according to Embodiment 3. In the integrated circuit 10C, a selector unit 106 receives two different reference clock signals REF1 and REF2 from an external oscillator 30C such as a quartz oscillator and selectively outputs any one of them as an operation clock signal CK. An analog signal processing unit 101 receives a multi-channel radio signal received by an antenna 20 and selects a desired channel from the received signal. More specifically, the analog signal processing unit 101 generates a local signal based on the operation clock signal CK and selects the desired channel using the local signal. A digital signal processing unit 102 performs digital demodulation of a signal of the channel selected by the analog signal processing unit 101. For example, in the case of digital television broadcasting, video data, audio data, caption data and other data are extracted by the digital demodulation. The digital signal processing unit 102 is operated in synchronization with the operation clock signal CK output from the selector unit 106. A control unit 104 outputs a control signal CTL to the selector unit 106 to control the signal selection by the selector unit 106. A table 105 stores information related to the control.

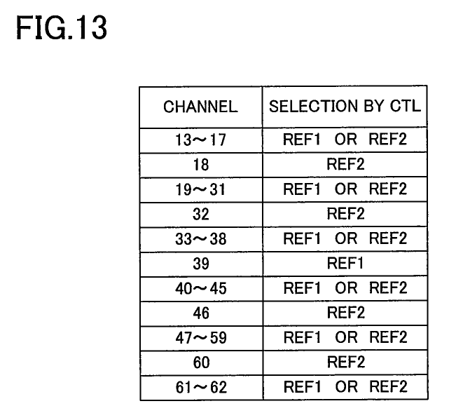

For example, when the frequencies of the reference clock signals REF1 and REF2 are 28 MHz and 35 MHz, respectively, the harmonics of the operation clock signals CK having these frequencies and the channels for the one segment broadcasting establish the relationship as shown in FIG. 4. Therefore, when the 28 MHz and 35 MHz reference clock signals REF1 and REF2 from the external oscillator 30C are received, a table shown in FIG. 13 is used as the table 105. By referring to the table 105, the control unit 104 designates the selector unit 106 to perform signal selection in response to the channel selected by the analog signal processing unit 101. That is, when the channel 18 and other channels are selected, the selection of the reference clock signal REF2 is designated. On the other hand, when the channel 39 is selected, the selection of the reference clock signal REF1 is designated. When the channel 13 and other channels are selected, the selection of reference clock signal REF1 or REF2 is designated as the frequency of the operation clock signal CK may be either of 28 MHz and 35 MHz.

According to the present embodiment, the structure of the control unit is more simplified than the structures of the control units of Embodiments 1 and 2. Therefore, the total circuit size is reduced to a further extent. In place of the operation clock signal CK output from the selector unit 106, any one of the reference clock signals REF1 and REF2 may be applied to the analog signal processing unit 101 in a fixed manner.

In each of the above-described embodiments, the digital signal processing unit 102 may be operated by suitably switching three or more operation clock signals CK. The table 105 can be omitted. When the table 105 is omitted, the control unit 104 may be configured so that it calculates a frequency of the operation clock signal which does not make any interference with the channel selected by the analog signal processing unit 101.

The present invention is not only limited to the receiver system, but also applicable to a sender system. For the realization of the sender system, the frequency of the operation clock signal is determined so that a harmonic of the operation clock signal for the digital signal processing unit does not make interference with a channel to be sent from the analog signal processing unit.

In each of the above-described embodiments, the analog signal processing unit 101, the digital signal processing unit 102 and other components may not always be provided on the same chip.

### (Applied Products)

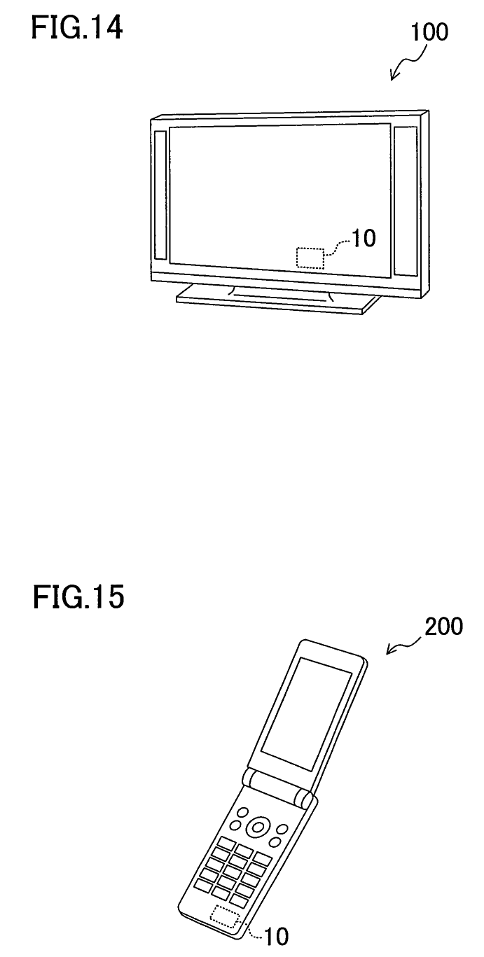

FIG. 14 shows an appearance of a multi-channel broadcasting receiver equipped with the multi-channel radio signal processing integrated circuit of the present invention. For example, a digital television receiving set 100, which is an example of the multi-channel broadcasting receiver, is equipped with the multi-channel radio signal processing integrated circuit 10 of the present invention. Further, FIG. 15 shows an appearance of a multi-channel radio communication device equipped with the multi-channel radio signal processing integrated circuit of the present invention. For example, a cellular phone 200, which is an example of the multi-channel radio communication device, is equipped with the multi-channel radio signal processing integrated circuit 10 of the present invention.

### INDUSTRIAL APPLICABILITY

The multi-channel radio signal processing integrated circuit of the present invention has high receiver sensitivity with respect to all channels. Therefore, it is useful for multi-channel broadcasting receivers for receiving broadband multi-channel digital television broadcasting and multi-channel radio communication devices for receiving/sending a broadband multi-channel radio communication signal.

1. An integrated circuit for processing a received multi-channel radio signal comprising:
an analog signal processing unit for generating a local signal based on a reference clock signal supplied from the outside of the integrated circuit and selecting a desired channel from the multi-channel radio signal using the local signal;
a digital signal processing unit for performing digital demodulation of a signal of the channel selected by the analog signal processing unit;
an operation clock generating unit for generating an operation clock signal for the digital signal processing unit based on the reference clock signal; and
a control unit for designating a frequency of the operation clock signal to be generated by the operation clock generating unit in response to the channel selected by the analog signal processing unit.

2. The integrated circuit of claim 1, wherein
the control unit designates the frequency of the operation clock signal by referring to a table in which channels selectable in the analog signal processing unit and frequencies of the operation clock signal to be designated are so associated with each other that a corresponding frequency is designated in response to a selected channel.

3. The integrated circuit of claim 1, wherein
the operation clock generating unit has a divider for dividing the frequency of the reference clock signal in a variable division ratio and the control unit designates the division ratio of the divider.

4. The integrated circuit of claim 1, wherein
the operation clock generating unit has a PLL for outputting the operation clock signal in response to the reference clock signal and the control unit designates an output frequency of the PLL.

5. The integrated circuit of claim 4, wherein
the PLL performs multiplication of the frequency of the reference clock signal to output the operation clock signal.

6. The integrated circuit of claim 4, wherein
the PLL performs fractional multiplication of the frequency of the reference clock signal to output the operation clock signal.

7. The integrated circuit of claim 4, wherein
the control unit designates the output frequency of the PLL so that a harmonic of the operation clock signal and a harmonic of phase noise in a loop band of the PLL are deviated from the channel selected by the analog signal processing unit.

8. An integrated circuit for processing a received multi-channel radio signal comprising:
an analog signal processing unit for generating a local signal based on a reference clock signal supplied from an external oscillator capable of changing an oscillatory frequency and selecting a desired channel from the multi-channel radio signal using the local signal;
a digital signal processing unit for receiving the reference clock signal as an operation clock signal and performing digital demodulation of a signal of the channel selected by the analog signal processing unit; and
a control unit for designating a frequency to be oscillated by the external oscillator in response to the channel selected by the analog signal processing unit.

9. An integrated circuit for processing a received multi-channel radio signal comprising:
a selector unit for receiving a plurality of different reference clock signals from an external oscillator and selectively outputting any one of the reference clock signals;
an analog signal processing unit for generating a local signal based on any one of the plurality of reference clock signals and selecting a desired channel from the multi-channel radio signal using the local signal;
a digital signal processing unit for receiving the reference clock signal output from the selector unit as an operation clock signal and performing digital demodulation of a signal of the channel selected by the analog signal processing unit; and
a control unit for controlling the signal selection by the selector unit in response to the channel selected by the analog signal processing unit.

10. The integrated circuit of claim 9, wherein
the analog signal processing unit receives the reference clock signal output from the selector unit.

11. A multi-channel broadcasting receiver comprising the integrated circuit of claim 1.

12. A multi-channel radio communication device comprising the integrated circuit of claim 1.
